(19) United States
(12) Patent Application Publication
(10) Pub. No.: US 2022/0034793 A1
(43) Pub. Date: Feb. 3, 2022

(54) CHARACTERISATION OF THROMBUS

(71) Applicant: Oxford University Innovation Limited, Oxford ( Oxfordshire) (GB)

(72) Inventors: Regent LEE, Oxford (GB); Mohammad ALKHALIL, Oxford (GB); Giovanni Luigi DE MARIA, Oxford (GB); Claire VALLANCE, Oxford (GB); Keith CHANNON, Oxford (GB)

(21) Appl. No.: 17/278,695

(22) PCT Filed: Sep. 26, 2019
(86) PCT No.: PCT/GB2019/052723

§ 371 Date: Mar. 23, 2021

(30) Foreign Application Priority Data
Sep. 26, 2018 (GB) 1815691.9

(51) Int. Cl. G01N 21/31; G01N 21/47; G01N 21/65

(52) U.S. Cl. CPC G01N 21/31; G01N 21/65; G01N 21/4738

(57) ABSTRACT

A method of characterizing a sample comprising a thrombus collected from a patient is described. The method comprises illuminating the sample with electromagnetic light, detecting light reflected or Raman scattered by the sample at a plurality of wavelengths, and classifying the sample based on a spectral analysis of the detected reflected or Raman scattered light. The spectral analysis may comprise principal component analysis PCA, discriminant function analysis DFA, or cluster analysis. The classification may be according to thrombus color, i.e., erythrocyte rich “red” versus erythrocyte poor “white”, or according to degree of a clinical marker, e.g., microvascular obstruction MVO.

The present invention relates to characterisation of a sample comprising thrombus collected from a patient.

Such samples are commonly collected during medical treatment. By way of example, a sample comprising thrombus may be collected during treatment for Acute myocardial infarction (AMI). AMI is mainly caused by development and build-up of thrombus following rupture or erosion of an atherosclerotic plaque, with consequent occlusion or subocclusion of a major coronary artery leading to myocytes necrosis (Reference 1). Mechanical restoration of coronary blood flow by primary percutaneous coronary intervention (pPCI) with stenting has had a dramatic impact on AMI prognosis, with significant reduction of both in-hospital and long term mortality (Reference 2).

However, in a proportion of AMI patients, accounting for up to 40% of cases, apparently successful restoration of coronary artery patency does not translate into a concomitant improvement in myocardial reperfusion (Reference 3). This condition is usually referred to as slow/no reflow and is related to coronary microvascular dysfunction and obstruction secondary to plugging of coronary microcirculation with athero-thrombotic debris embolized distally from the culprit coronary lesion during pPCI (Reference 4). Slow/no reflow has significant prognostic implications, being associated with higher risk of arrhythmic events, future readmission for heart failure, and ultimately long-term mortality (References 5 to 7). Preventing and treating slow/no reflow is still an open challenge in the field of cardiovascular medicine.

Over the past decade, manual thrombectomy has been introduced into the treatment plan for AMI patients (Reference 8). Coronary thrombus is removed from the culprit vessel before proceeding to stenting, with a view to preventing distal embolization of thrombotic debris. Initial studies associated manual thrombectomy with improved myocardial reperfusion, secondary to reduced occurrence of distal embolization (Reference 9). Although the routine application of manual thrombectomy has recently been put into question with the publication of the TASTE and TOTAL trials, which failed to show a significant difference in mortality between patients who did and did not undergo the procedure (References 10 and 11), current guidelines recommend the targeted application of manual thrombectomy in a subset of patients with AMI and clear evidence of large coronary thrombotic burden (References 2 and 12). Thus, in those cases a sample comprising thrombus is collected from the patient.

Alongside the therapeutic utility of manual thrombectomy, the samples thereby collected during AMI have also contributed to improve understanding of the pathophysiology underlying plaque instability and thrombus development in patients with AMI (Reference 13). Notably, histopathology studies have shown that in up to 40-50% of patients, retrieved coronary thrombi are days to weeks old, suggesting that the process of plaque instability and consequent thrombus build-up may occur gradually (Reference 14). It is also known that thrombus composition correlates with clinical outcome in AMI: erythrocyte-rich thrombi are more often associated with greater inflammatory insult, larger thrombotic burden, and angiographically detectable no reflow (Reference 15 and 16).

Such studies have beneficially advanced scientific and medical understanding, but are not applied in the clinical management of patients. Generally, such studies have required time-consuming laboratory analysis and have been performed late in the patient pathway, or long after treatment, mostly using proteomics research methods. The results of such studies have not been used to inform clinical decisions at the point of care. Indeed, samples comprising thrombus are not analysed at all in the course of routine clinical care.

According to a first aspect of the present invention, there is provided a method of characterising a sample comprising thrombus collected from a patient, the method comprising: illuminating the sample with optical electromagnetic radiation; detecting electromagnetic radiation scattered by the sample at a plural number of wavelengths; and classifying the composition of the sample using a spectral analysis of the detected electromagnetic radiation at the plural number of wavelengths.

This method therefore uses a multivariate analysis of measurements of electromagnetic radiation scattered by the sample comprising thrombus collected from a patient at a plural number of wavelengths to classify the composition of the sample.

The method is rapid and convenient to perform because reflectance may be measured at an early stage after collection of the sample, with minimal or even no sample preparation, using equipment that is straightforward to use and may be automated to take measurements in seconds, and at the point of care to provide a classification in real time.

This approach, in contrast to using a measurement at a single wavelength has been shown to provide robust classification of samples into multiple different categories, which could in the simplest case be two categories, for example ‘red’ and ‘white’, or could be a larger number of categories or classification on a continuum. Further, it has been demonstrated that the measurements of the sample may be used to provide a classification that is clinically significant, because the composition of thrombus relates to the clinical outcome. The optical measurements may provide detailed chemical information on thrombus composition. By way of example, in a simple form, the classification could be an objective classification of the thrombus being “red” or “white” (i.e. erythrocyte rich or erythrocyte poor), while in more detailed forms the classification of the thrombus can be classification on a continuum, for example with respect to a correlation with-a clinical marker, for example microvascular obstruction. The categories may be correlated with clinical parameters and so represent different risk levels for the patient from which the sample is collected.

As such the classification may contribute to clinical diagnosis, prediction of clinical outcomes, stratification, treatment decisions, optimisation of treatment regimes and management of vascular conditions which produce thrombus. Thus, a treatment for the patient may subsequently be based on the classification. Conditions that do or may lead to generation of thrombus to which the present invention is applicable include, without limitation, AMI (including ST-segment elevation myocardial infarction (STEMI)), acute cerebral infarction (i.e. stroke), acute limb ischaemia, pulmonary embolism, deep vein thrombosis, other thromboembolisms, trauma, sepsis, aortic aneurysm, pseudo-aneurysm, haemodialysis grafts, vein bypass grafts, and acute or chronic haematoma.

The optical electromagnetic radiation may be ultraviolet, visible or infrared, and may have a wavelength in a range from a lower limit of 100 nm to an upper limit of 1 mm. Preferably, the lower limit may be 190 nm or 400 nm. Preferably the upper limit may be 20 μm. The wavelength of the illuminating electromagnetic radiation is chosen so that the scattered electromagnetic radiation that is detected provides information on rotational, vibrational and/or electronic spectroscopic transitions within the sample.

The wavelengths used may advantageously include a wavelength in a range from 585 nm to 595 nm. Such a wavelength has been found to provide high discriminatory power.

In one alternative, the optical measurements may be reflectance measurements.

In the case of reflectance measurements, the plural number of wavelengths may be a continuous spectrum of wavelengths, for example as measured by a detector that is a spectroscope.

However, it has been found that classification of reflectance measurements may be performed using a smaller plural number of wavelengths, for example at most 50, at most 20 or at most 10. In such a case, good discriminatory power has been found when the plural number is at least three, preferably at least four, at least five, or more preferably at least six.

Reducing the number of wavelengths simplifies the taking of measurements. For example, it is possible to use plural wavelength-selective filters corresponding to the plural number of wavelengths, and for the detector to measure the reflectances of the sample at the plural number of wavelengths from light reflected from the sample and having wavelengths selected by the filters, in turn or in parallel. Such an arrangement avoids the need for a spectroscope as a detector.

In another alternative, Raman spectroscopy may be used. That is, the electromagnetic radiation that is detected may be electromagnetic radiation that is Raman scattered over a range of frequencies. In that case, the classification of the composition of the sample is performed on the basis of the Raman scattered electromagnetic radiation.

Where the sample is disposed on a support, for example a filter on which the samples were collected, then the method may further comprise analysing the detected electromagnetic radiation to determine the contribution thereto of the support, and adjusting the detected electromagnetic radiation to remove the contribution thereto of the support. In that case, the step of classifying the sample may be performed using the detected electromagnetic radiation after being adjusted.

The classification may be performed using any suitable technique, typically by comparison to reference data representing possible classifications of compositions.

According to a second aspect of the present invention, there is provided a method of characterising a sample comprising thrombus collected from a patient, the method comprising classifying the composition of the sample using a spectral analysis of detected electromagnetic radiation scattered at a plural number of wavelengths by the sample that is illuminated with optical electromagnetic radiation.

Such a method corresponds to the first aspect of the present invention, but including only data processing steps. As such, there may be provided a computer program capable of execution by a computer system and configured, on execution, to cause the computer system to perform a method according to the second aspect. The computer program may be stored on a computer-readable storage medium

According to a third aspect of the present invention, there is provided an apparatus for characterising a sample comprising thrombus collected from a patient, the apparatus comprising a an optical measurement device arranged to receive the sample and comprising an illumination system arranged to illuminate the sample with optical electromagnetic radiation and a detector arranged to detect electromagnetic radiation scattered by the sample at a plural number of wavelengths. Thus, the apparatus in operation may perform a method similar to the first aspect.

To allow better understanding, an embodiment of the present invention will now be described by way of non-limitative example with reference to the accompanying drawings, in which:

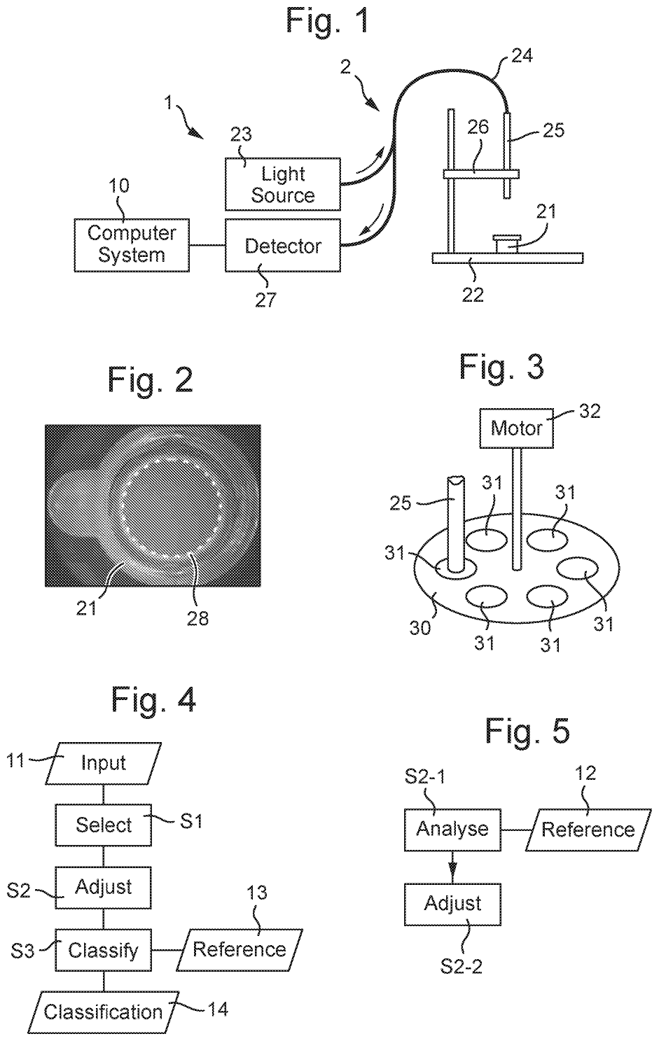

FIG. 1 is a schematic side view of an apparatus for characterising a sample;

FIG. 2 is an image of a filter supporting a sample;

FIG. 3 is a perspective view of a possible modification to an optical measurement device of the apparatus;

FIG. 4 is a flow chart of an analysis method performed by a computer system of the apparatus;

FIG. 5 is a flow chart of an optional adjustment step in FIG. 4;

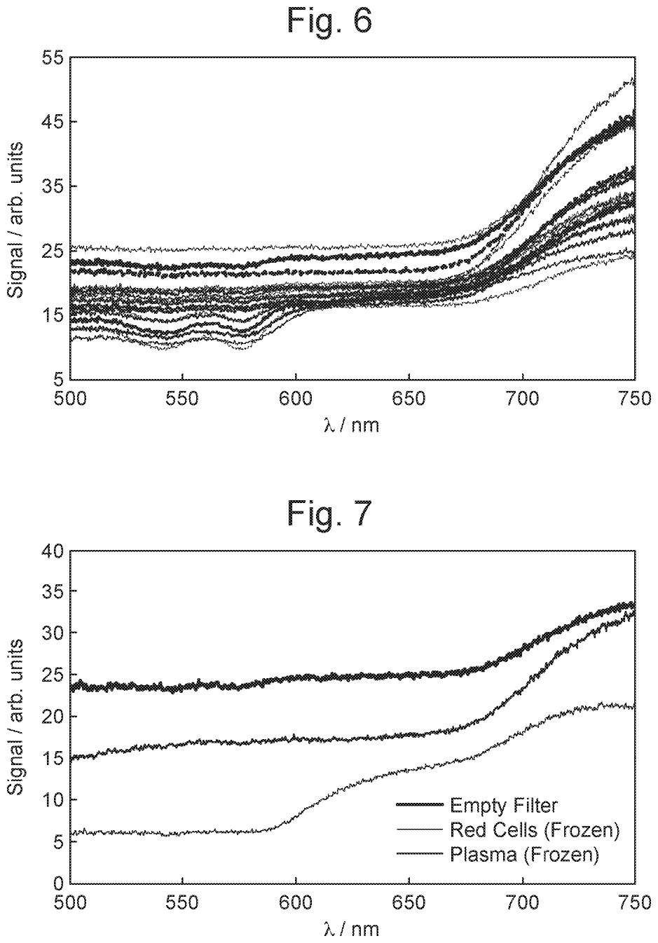

FIG. 6 is a graph of typical reflectance spectra measured by the apparatus;

FIG. 7 is a graph of three basis spectra (profiles) measured for red cells, plasma, and an empty filter;

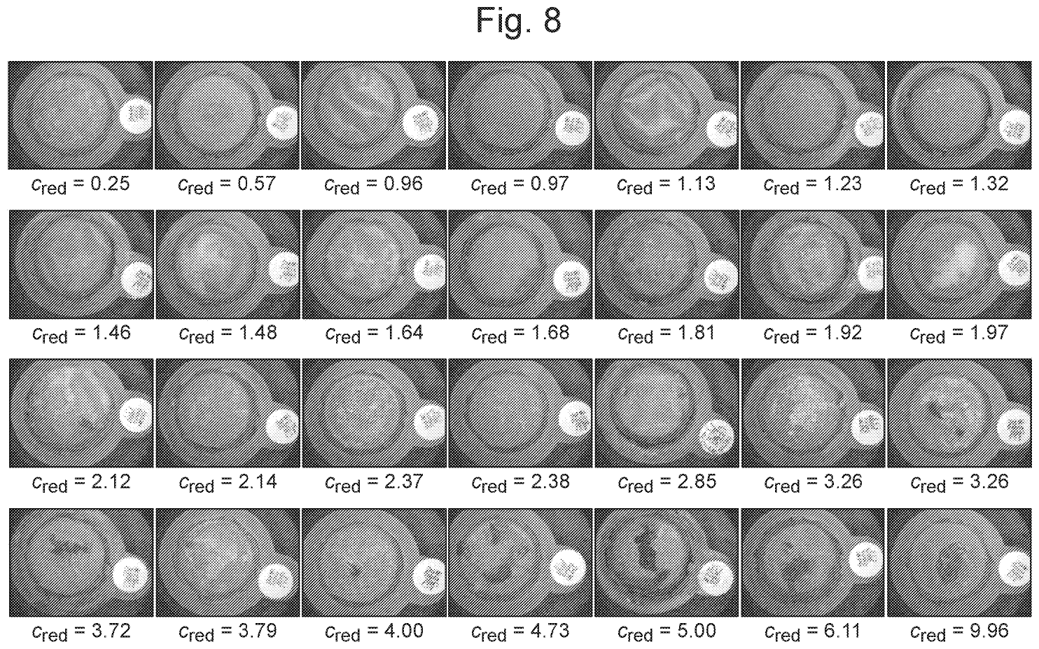

FIG. 8 is images of a subset of samples, together with fitting coefficients derived for red blood cells;

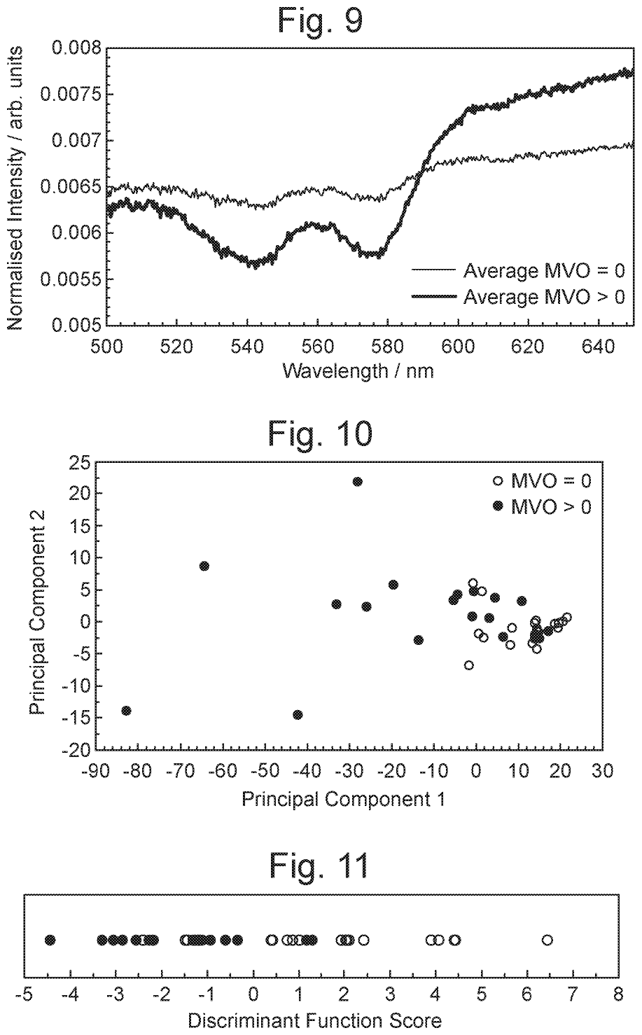

FIG. 9 is a graph of averages of normalised spectra belonging to the two patient groups having high and low MVO;

FIG. 10 is a plot of two principal components derived by PCA of the spectra for the two patient groups;

FIG. 11 is a plot of discriminant functions scores derived by DFA of spectra of the two patient groups;

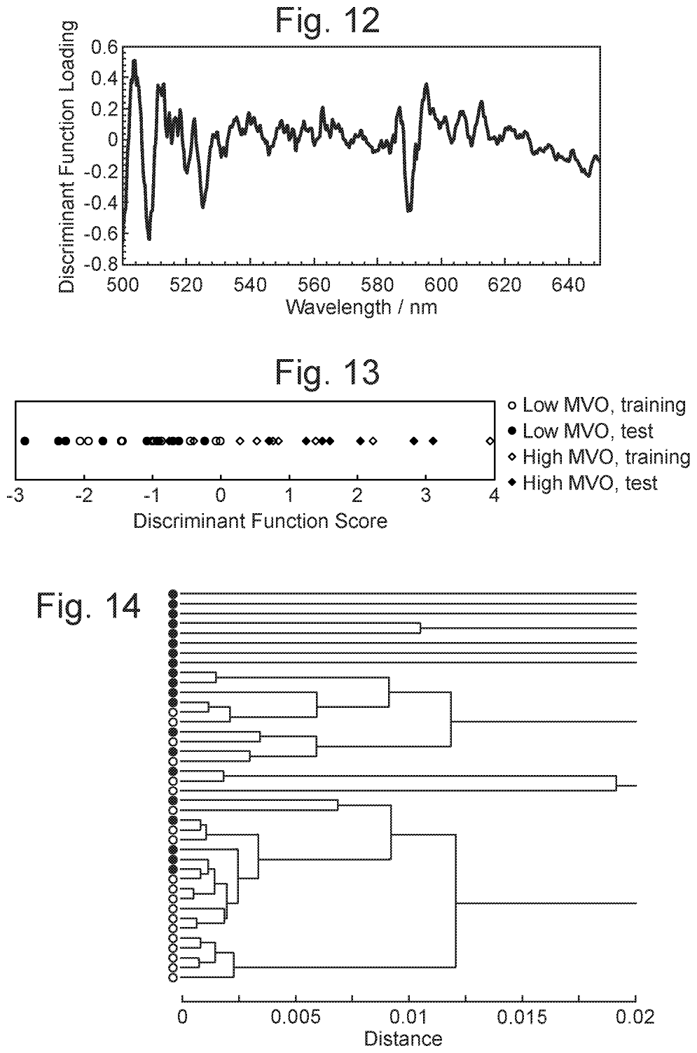

FIG. 12 is a loading plot resulting from the DFA;

FIG. 13. is a plot of discriminant functions scores derived by DFA with data set split into training and test subsets;

FIG. 14 is a plot of the results of a cluster analysis of the spectra of the two patient groups;

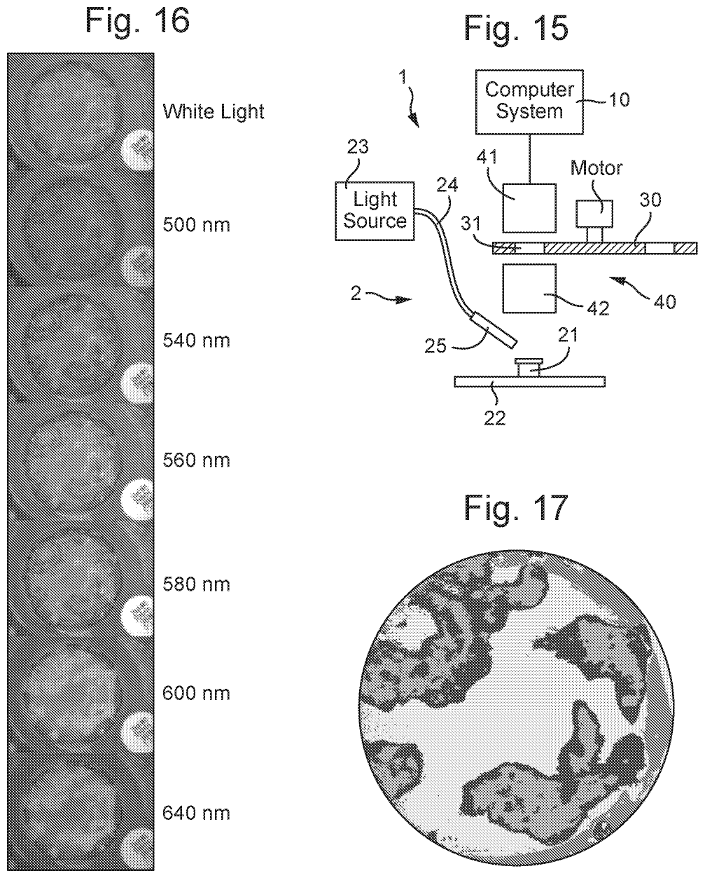

FIG. 15 is a schematic view of an alternative form of the apparatus for characterising a sample;

FIG. 16 is a set of spectral reflectance images for a thrombus sample; and

FIG. 17 shows the results of a k-means cluster analysis on the image from FIG. 16, in which the pixels have been classified into four groups based on their reflectance spectra.

There will now be described an apparatus that implements a method for characterising a sample comprising thrombus.

Herein, the sample comprising thrombus is a sample that is collected from a patient, for example during a treatment of the patient. The sample may also comprise additional components, including other blood constituents or bodily fluids.

The sample may be collected from the patient suffering any condition, for example AMI, stroke or one of the other conditions specified above. The sample may be collected during a treatment for the condition, during a procedure specifically for the purpose of characterisation, or otherwise.

FIG. 1 illustrates an apparatus 1 for characterising the sample, comprising a optical measurement device 2 and a computer system 10. The apparatus 1 may be used to characterise the sample immediately after collection at the point of care, although that is not essential and the apparatus 1 may also be used to characterise samples that have been stored subsequent to collection.

The optical measurement device 2 in the example shown in FIG. 2 is a reflectance measurement device that measures the reflectance of the sample at plural number of wavelengths and is arranged as follows.

The optical measurement device 2 receives the sample disposed on a support 21 which is itself located on a platform 22 of the optical measurement device 2. By way of example, the support 21 may comprise a filter, e.g. made of plastic, which may be a filter used to collect the sample in a conventional manner.

The optical measurement device 2 includes the following components for measuring reflectances of the sample.

The optical measurement device 2 includes an illumination system arranged to illuminate the sample with optical electromagnetic (EM) radiation that comprises an EM source 23 and an optical fibre arrangement 24 configured to direct EM radiation from the EM source 23 onto the sample through a reflectance probe 25. The reflectance probe 25 is located relative to the support 21 by a stand 26 mounted on the platform 22. In the example shown in FIG. 1, the reflectance probe 25 is located directly above the support 21 and so directs EM radiation onto the sample along an axis normal to the plane of the support 21 which is a filter. In a case where the support has relatively high walls around the filter element on which the sample is located, this permits illumination without further optics or destruction of the support.

The EM source 23 outputs light at least at a plural number of wavelengths used for characterisation of the sample, and optionally at further wavelengths too. Although the term “light” is used, this may be any optical EM radiation including ultraviolet, visible and infrared. As discussed further below, the wavelengths used are typically in a range from a lower limit of 100 nm to an upper limit of 1 mm. At such wavelengths, the reflectance provides information on rotational, vibrational and/or electronic transitions within the sample. Thus, the EM source 23 may be a broadband source outputting light simultaneously at such wavelengths. For example, the EM source 23 may be a tungsten-halogen lamp.

The optical measurement device 2 also includes a detector 27 that detects EM radiation reflected from the sample at a plural number of wavelengths which provides the reflectance of the sample at the plural number of wavelengths. In this example, the reflectance probe 25 is arranged, as well as outputting illuminating light, to collect reflected light from the sample along the same axis as the illuminating light, so that the reflected light is directed by the optical fibre arrangement 24 to the detector 27, although other optical configurations could be used.

The reflectance probe 25 is located relative to the support 21 so as to collect light from an extended area of the sample, corresponding in this example to the entire base of the filter element as shown in FIG. 2 which is an image of the support 21 by the dotted line 28. As a result, in this example the measured reflectances are averaged across that area of the sample.

In order to detect EM radiation reflected from the sample at the plural number of wavelengths, the detector 27 may comprise a spectrometer. In that case the detector 27 is configured to measure reflectances at a plural number of wavelengths that comprise a continuous spectrum of wavelengths, for example by scanning through the wavelengths or dispersing them onto a pixellated sensor. All or some of the measurements taken in this way may be used in the subsequent analysis.

Use of a spectrometer as the detector is advantageous in that it provides the maximum amount of information for characterisation of the sample across the wavelength range of the spectrometer. However, a spectrometer is relatively expensive and it has been appreciated that classification may be performed using a smaller plural number of wavelengths, for example at most 50, at most 20 or at most 10. In such a case, good discriminatory power has been found when the plural number is at least three, preferably at least four, at least five or more preferably at least six. The number of wavelengths used is the maximum number of categories into which the classification may be performed.

Use of a smaller plural number of wavelengths allows modification of the optical measurement device 2 in which the detector 27 is of a simpler form, for example a broadband intensity sensor, such as a photodiode. FIG. 3 shows an example of a modification of the optical measurement device 2 allowing the use of such a form of detector 27, as follows.

The optical measurement device 2 by inclusion of rotatable plate 30 (which may be referred to as a filter wheel) in which plural wavelength-selective filters 31 are provided angular spaced around the axis of rotation of the rotatable plate 30. Each filter 31 has a passband centred at a respective one of the desired wavelengths to be used for characterisation, so that passage of light through the filters 31 selects the wavelength of the light. The filters 31 may have, for example a 10 nm FWHM (full width half maximum) passband. Thus, while six filters 31 are shown in FIG. 3 as an example, in general there are the same number of filters 31 as wavelengths to be used in the characterisation. In a non-limitative example, the filters 31 may be centred at wavelengths of 500 nm, 540 nm, 560 nm, 580 nm, 600 nm and 640 nm.

The rotatable plate 30 is located to arrange one of the filters 31 in the optical path between the reflectance probe 25 and the support 21 so that light passing there between passes through the filter 31 arranged in the optical path. As a result the detector 27 measures the reflectance of the light having a wavelength selected by passage through the filter 31.

The rotational axis of the rotatable plate 30 is eccentric to the optical path so that rotation thereof allows the filters 31 to be arranged in the optical path in turn. The optical measurement device 2 includes a motor 32 which acts as a drive arrangement to drive such rotation of the rotatable plate 30. In use, the motor 32 is operated to arrange the filters 31 in the optical path in turn, allowing the reflectances at the plural wavelengths to be measured in turn.

As an alternative, the rotatable plate 30 could be replaced by a plate that is moved linearly to select the filters 31.

As an alternative to measuring reflectances in turn, the optical measurement device 2 could be modified to measure plural reflectances in parallel, for example by being arranged to pass light reflected from the sample through plural wavelength-selective filters and measuring the light passed through each of the filters 31 in parallel.

As will be apparent, the apparatus 1 has a simple construction and is rapid and convenient to operate. This permits the reflectances to be measured at an early stage after collection of the sample, with minimal or even no sample preparation. Operation of the apparatus may be automated to take measurements in seconds, and at the point of care in order to provide a classification in real time. The apparatus 1 could be modified to be integrated into a housing having an opening for receipt of the support.

In any form of the apparatus 1, but in particular when the rotatable plate 30 is used, the detector 27 may be an image sensor, thereby yielding a spectral imaging system. This will allow recording of low-resolution spectral information for each pixel in the image, corresponding to respective points in the sample.

FIG. 15 shows an alternative form of the apparatus 1 in which the optical measurement device 2 is modified as follows to provide a spectral imaging system that detects images of electromagnetic radiation scattered by different points of the sample at the plural number of wavelengths, instead of detecting electromagnetic radiation averaged across an area of the sample. In this alternative form, the apparatus 1 is a reflectance measurement device which receives the sample disposed on a support 21 as described above and includes an illumination system comprising an EM source 23, an optical fibre arrangement 24 and a reflectance probe 25 arranged as described above for illuminating the sample. However, the apparatus 1 is modified to replace the detector 27 by an imaging detection system 40 arranged as follows.

The imaging detection system 40 comprises an image sensor 41 arranged to capture images and a lens arrangement 42 arranged to form an image of the sample on the image sensor 41. Thus, the image sensor 41 detects reflectance images of the sample. The image sensor 41 may be for example a CMOS device and may be monochrome.

In order to provide wavelength selectivity, the imaging detection system 40 also includes a rotatable plate 30 arranged as described above and shown in FIG. 3, including plural wavelength-selective filters 31. The rotatable plate 30 is located to arrange one of the filters 31 in the optical path between the reflectance probe 25 and the image sensor 41 so that light passing therebetween passes through the filter 31 arranged in the optical path. In the example shown in FIG. 15, this is achieved by locating the 30 between the image sensor 41 and the lens arrangement 42, but it could be located elsewhere in the optical path. As a result of providing the filter in the optical path, the image sensor measures the reflectance of the light having a wavelength selected by passage through the filter 31. By rotating the 30 as described above, the filters 31 are arranged in the optical path in turn, allowing the reflectance images at the plural wavelengths of the filters 31 to be captured in turn.

The illumination system may be modified in various ways, an optical fibre arrangement 24 and a reflectance probe 25 are not essential. In one example, the illumination system may be replaced by a ring light mounted on the lens arrangement 42, so being integrated within the imaging detection system 40

In any case, there is no need for an optical fibre arrangement or a reflectance probe for a spectral imaging measurement of the type described, so this bit should probably go.

As an alternative, the optical measurement device 2 may be a Raman spectroscopy device that measures the Raman spectrum over a range of frequencies. In this case, the optical measurement device 2 may have the same arrangement as shown in FIG. 2 and described above except that the EM source 23 is formed by an appropriate laser source, and the reflectance probe 25 is replaced by a Raman probe. Typically, a notch filter is included along the detection path to cut out the wavelength of the excitation light.

For an imaging Raman spectroscopy device, imaging may be performed by rastering the laser across the sample and measuring the Raman-scattered light at each point. This would employ a similar setup, except with the probe closer to the sample surface to give a smaller spot size, and with the sample mounted on a translation stage for scanning to repeat the Raman measurements at different positions on the surface of the sample to build up images.

More generally, the optical measurement device 2 may be arranged to perform any kind of microscopy where scattered electromagnetic radiation that provides information on rotational, vibrational and/or electronic interactions of the sample is detected. The computer system 10 will now be described. The computer system 10 receives the output from the optical measurement device 2 and analyses it to classifying the composition of the sample using an analysis method.

The computer system 10 may be any type of computer system but is typically of conventional construction. The computer system 10 executes a computer program configured to cause the computer system 10 to perform the analysis method on execution. The computer program may be written in any suitable programming language. The computer program may be stored on a computer-readable storage medium, which may be of any type, for example: a recording medium which is insertable into a drive of the computing system and which may store information magnetically, optically or opto-magnetically; a fixed recording medium of the computer system such as a hard drive; or a computer memory.

The analysis method is shown in FIG. 4 and performed as follows.

The analysis method operates on input data 11 representing the output from the detector 27 being the measured reflectances in the case of the reflectance measurement device or the Raman spectrum in the case of the Raman spectroscopy device.

In step S1, the wavelength components of the output to be used in the analysis are selected. This may be all or some of the wavelength components output by the detector 27, depending on the nature of the optical measurement device 2.

Step S2 is an optional adjustment step shown in more detail in FIG. 5 and performed as follows.

In step S2-1, the detected EM radiation is analysed to determine the contribution thereto of the support 21. That may performed by comparison of the detected EM radiation to support reference data 12 representing profiles of (1) the spectral contribution of the support 25 and (2) the spectral contribution of one or more constituents of thrombus and blood, for example white blood cells and red blood cells. In step S2-1, the detected EM radiation may be fitted to the profiles, thereby deriving corresponding fitting coefficients. The fitting coefficient for the profile of the spectral contribution of the support 25 may be taken as the contribution of the support 25 to the measured spectrum.

In step S2-2, the detected EM radiation are adjusted to remove the contribution thereto of the support 25 determined in step S2-1. The remainder of the analysis method then operates on the detected EM radiation that have been adjusted.

Step S2 may be useful in the situation that the detected EM radiation are based on light collected from an area that extends beyond the edge of the sample so that the support 21 contributes to the measurements. However, this step is not essential and may be omitted, for example where light is collected from the sample only or where the subsequent classification (described below) takes the support 25 into account.

In step S3, the detected EM radiation is analysed to classify the composition of the sample. This may be performed by comparison of the detected EM radiation to reference data 13 representing possible classifications of compositions. Step S3 may produce classification data 14 representing the classification.

The reference data 13 is stored in the computer system 10 having been determined by experimental study of known samples using the optical measurement device 2. Any suitable classification technique may be used as the basis for classification of the known samples and derivation of the reference data 13, including a variety of unsupervised and supervised multivariate analysis methods, for example principal component analysis (PCA) followed by discriminant function analysis (DFA) or other classification techniques, including machine learning techniques.

Typically, where measured reflectances at a plurality of wavelengths are used, the classification technique may involve transformation of measured reflectances into a vector having a number of dimensions less than the number of wavelengths. In that case, the reference data 13 represents the classification in the transformed space, and so step S3 involves transforming the measured reflectances into a vector having the reduced number of dimensions, and classifying the composition sample on the basis of the vector thus derived.

The classification may in general be any classification of the composition. The classification may be into discrete classes or a linear classification having a scalar representation.

In some cases, the sample may be classified with respect to a degree of a clinical marker. Any desired clinical biomarker may be used, for example microvascular obstruction (MVO).

In a simpler case, the classification may be a classification of the colour of the thrombus, for example being “red” or “white”. This is analogous to a clinician visually classifying the sample, but whereas a visual classification is subjective and may be applied inconsistently by different individuals, the present analysis can provide an objective and robust classification. Such a classification may be performed, for example, in a similar manner to step S2-1 by using reference data 13 representing plural profiles for different types of thrombus. In that case, step S3 may be performed by fitting the detected EM radiation to the profiles to derive fitting coefficients that represent a classification of the thrombus in the sample.

Detected EM radiation such as measured reflectances of the sample at the plural number of wavelengths or the Raman spectrum may be used to provide a classification that is clinically significant, because the composition of the thrombus relates to the clinical outcome. The detected EM radiation may provide detailed chemical information on thrombus composition.

Typically, the classification data 14 representing the classification of the thrombus may be output and/or displayed for use by a clinician, although it could alternatively be used in a further step performed by the computer system 10.

In the alternative that the detector 27 is an image sensor, the analysis described above may be performed in numerous ways to classify the composition of the sample using a spectral analysis of the detected electromagnetic radiation at the plural number of wavelengths.

In one type of example, the composition of the sample as a whole may be classified combining the information from all the pixels of the image, corresponding to respective points of the sample.

In another type of example, the composition of the sample may be classified at each pixel of the image, corresponding to respective points of the sample. This allows each of the pixels to be classified by type. Since the sample may be inhomogeneous, this detailed analysis may correlate the measured spectral data with clinical parameters. This approach also provides a quick semi-quantitative measure of the amount of thrombus extracted from the patient, which may itself correlate with clinical outcomes.

In one approach, each individual pixels may be classified using a spectral analysis of the type described above that refers to reference data 13. This allows for correlation with clinical information, for example in order to stratify patients according to their cardiac risk. In another approach, a clustering analysis may be performed without reference to reference data, using the spectral information of each pixel is used to cluster pixels into groups using a spectral analysis of the reflectance spectra to identify groups that are similar, and thereby to categorise the pixels into a predetermined (or user-defined) number of groups. The maximum number of meaningful groups is equal to the number of wavelengths employed, in this case six.

In each case, the pixels assigned to each group can clearly be correlated with visual characteristics of the image. This simple analysis is able to separate “thrombus pixels” corresponding to points of the sample where a thrombus is present from “background pixels” corresponding to points of the sample where no sample is present, and is also able to identify sub-categories within the thrombus pixels. The spatially-resolved information allows the user to focus solely on the pixels corresponding to thrombus, improving the specificity of the approach over the ‘single spectrum’ method outlined previously.

Subsequently, the pixels assigned to each of the groups within the ‘thrombus’ pixels may then be classified using a spectral analysis of the type described above that refers to reference data 13. This allows for correlation with clinical information, for example in order to stratify patients according to their cardiac risk.

Any number of image analysis tools (for example, the multivariate analysis methods outlined above, or any of a wide variety of spatial analysis and other methods developed specifically for image analysis) may be applied to the data set in order to uncover correlations between the spectral data and the clinical data for a cohort of patients. Given a sufficiently large patient data set on which to train the analysis algorithms chosen, the spectral images recorded for individual patients can then be used to predict their individual level of risk.

The classification may be used to select a treatment for the patient based on the classification. As the classification is clinically significant, it may be used for a wide variety of purposes in clinical diagnosis, prediction of clinical outcomes, stratification, treatment decisions, optimisation of treatment regimes and management of vascular conditions which produce thrombus. Similarly, the classification may be used to select management of patients who have a wide range of conditions leading to generation of thrombus including, without limitation, AMI (including ST-segment elevation myocardial infarction (STEMI)), acute cerebral infarction (i.e. stroke), acute limb ischaemia, pulmonary embolism, deep vein thrombosis, other thromboembolisms, trauma, sepsis, aortic aneurysm, pseudo-aneurysm, haemodialysis grafts, vein bypass grafts, and acute or chronic haemotoma.

The methods disclosed herein were validated by reflectance spectroscopy of retrieved coronary thrombi as a diagnostic tool in AMI patients as follows. The occurrence of suboptimal myocardial reperfusion was predicted by correlating spectral features with microvascular obstruction (MVO) determined via cardiac magnetic resonance imaging (cMRI).

To demonstrate the efficacy of the method, clinical sample and data were collected in an ethically approved study. The study included patients referred to the John Radcliffe Hospital Heart Centre, Oxford, for pPCI to treat ST elevation myocardial infarction (STEMI).

PPCI was performed according to international guidelines. All patients were on double antiplatelet treatment at the time of the procedure, and anticoagulation was achieved with bivalirudin using a 0.75 mg/kg bolus followed by an infusion of 1.75 mg/kg/min for up 4 hours after the procedure as clinically warranted. Glycoprotein IIbIIIa inhibitors were used and manual thrombectomy performed at the discretion of the treating clinicians. Since the reflectance spectroscopy measurements involve the analysis of thrombus material, only patients who had manual thrombectomy performed as part of the pPCI could be included in the study.

After the culprit vessel was wired, aspiration thrombectomy was performed, if deemed clinically indicated by the operator, using a conventional rapid-exchange 6French compatible thrombus aspiration catheter (e.g. Export (Medtronic), VMax (Stron Medical), or Hunter ((IHT Cordynamic)). The thrombectomy catheter was advanced proximal to the culprit site and then moved slowly forward and backwards while applying suction via a 20 ml luer-lock syringe connected to the proximal hub of the central lumen of the thrombectomy catheter. A minimum of three passages with the aspiration catheter across the culprit site were performed. The aspirated blood and thrombus was filtered using a 40 μm pore-sized cell strainer (BD Falcon, Italy, Milan) provided with the aspiration catheter kit. Thrombus material collected in the strainer was washed with saline and frozen at −80° C.

Reflectance spectral information has been recorded using two approaches, namely: (i) use of the optical measurement device 2 to record a single reflectance spectrum of the reflectance averaged across the area of the sample at high spectral resolution from the entire base of the filter in which the thrombus samples were collected; (ii) use of a spectral imaging system to record reflectance images at six selected wavelengths, allowing the spectral information to be classified pixel by pixel for each point on the sample.

The first approach using a single reflectance spectrum for each sample averaged across an area of the sample was carried out as follows.

Reflectance spectra were recorded using the optical measurement device 2 shown in FIG. 1 for the frozen thrombus samples on supports 21 which were the filters in which they were originally collected during the catheterisation and extraction procedure.

The EM source 23 was a tungsten-halogen source (Ocean Optics HL-2000-HP-FHSA) and the optical fibre arrangement 24 used 400 μm optical fibre and a corresponding reflectance probe 25 (Ocean Optics QR400-7-VIS-BX). The reflectance probe 25 illuminated the area shown in FIG. 2. The detector 27 was a spectrometer (Ocean Optics HR4000 UV/vis). Reflectance spectra for each sample were acquired over the wavelength range from 195 to 1130 nm via the OceanView software suite. FIG. 6 shows typical examples of the recorded spectra.

Spectra were also recorded for an empty filter for use in background subtraction and data fitting. The bandwidth of the EM source 23 meant that useful reflectance was measured over a range of wavelengths from around 500 nm to 800 nm.

The measured reflectances were highly averaged, containing contributions both from thrombus and from the filter base, with the ratio of the two contributions varying depending on the volume of thrombus in a given sample. In addition, the thrombus collected from a given patient is often not homogeneous, such that the spectra are also averaged over the different types of thrombus present in the sample.

In addition to the measurements on the samples from a clinical study, red cells and plasma were extracted from a small sample of blood donated by a healthy volunteer. Fresh and frozen samples of whole blood, red cells, and plasma were prepared in the same filters used to contain the clinical samples, and reflectance spectra were recorded for each sample using the experimental setup described above. FIG. 7 shows the spectra that were recorded. These were later used as profiles for fitting the clinical spectra.

The measurements were made non-destructively on the clinical samples within the relatively high-walled filters in which they were collected, imposing the geometrical constraint that the samples must be illuminated and light collected from directly above the samples. Using frozen samples avoids experimental artefacts caused by detection of specularly reflected light from the highly reflective wet surface of fresh samples, given the geometry of the optical path of the reflected light. Using a different excitation and detection geometry it would be relatively straightforward to eliminate detection of specular reflections from fresh samples, but this would require removing the sample from the support 21.

Two general approaches were used to analyse the spectral data.

In the first analysis approach, the spectra recorded for frozen red cells, frozen plasma, and an empty filter were used as basis spectra (profiles) to perform a linear fit to each of the thrombus spectra. This assumed that the spectral features within the thrombus spectra arose primarily from spectral features of these three components. Prior to performing this analysis, each spectrum was cropped to the wavelength range from 500 to 750 nm over which the spectra display a good signal-to-noise ratio. Each thrombus spectrum S_{thrombus}(λ) was fitted to the equation:

S_{thrombus}(λ)=c₀+c_{red}·S_{red}(λ)+cₚₗₐₛₘₐ·Sₚₗₐₛₘₐ(λ)+c_{filter}·S_{filter}(λ)

Here, S_{red}(λ), Sₚₗₐₛₘₐ(λ) and S_{filter} (λ) are the basis spectra, and c_{red}, cₚₗₐₛₘₐ, and c_{filter} are fitting coefficients which are proportional to the contributions to the spectrum from each of the red cells, plasma, and filter, with co being a constant offset. Good fits were obtained in all cases, indicating that the three components considered account for most of the spectral features observed in the thrombus spectra. In order to provide a crude spectral measure of ‘redness’, the c_{red} fitting coefficients returned from all the clinical samples were resealed to span the range from 0 to 10, and could be correlated with the visual appearance of the samples.

The fitting coefficient c_{red} is of particular interest, because the red cell content of thrombus is known to correlate with patient outcome. Simple macroscopic visual classification of coronary thrombi as either ‘white’ (platelet-rich) or ‘red’ (erythrocyte-rich) may therefore be used as a diagnostic/triaging tool. White thrombi have been described more often in patients with low thrombotic burden, and are associated with more favourable clinical outcomes, while red thrombi are more often encountered in late presenters with large thrombotic volume, suboptimal myocardial reperfusion, and a worse long-term prognosis (Reference 17). Despite the prognostic potential of a simple ‘red’/‘white’ classification, visual classification has not reached clinical practice, partly due to the subjective nature of the classification process (Reference 13).

The values of the fitting coefficient c_{red} obtained in the present analysis were found to correlate well with the visual appearance of the samples. By way of illustration, FIG. 8 shows images of a subset of samples, together with their fitting coefficients c_{red} (resealed so that the complete set of coefficients spans the range from 0 to 10). Although FIG. 8 is in black and white for the purposes of this patent application, the original images were in colour and show good correlation between fitting coefficients c_{red} and the visual appearance of the samples.

In the second analysis approach, classification with respect to MVO was studied.

The MVO for individual samples was determined via cardiac magnetic resonance imaging (cMRI) within 48 hours from completion of pPCI with MVO presence and extent assessment using the following protocol.

cMRI was performed using a 3.0 Tesla scanner (either MAGNETOM TIMTrio or MAGNETOM Verio, Siemens Healthcare, Germany). The protocol included SPSS cine imaging, T2-weighted (T2W) imaging, native Shortened Modified Look-Locker Inversion recovery (ShMOLLI) T1 mapping, T2* mapping, and late gadolinium enhancement (LGE). Sequence acquisition was performed as previously described (19). Briefly, T2W was performed using a T2-prep-SSFP single-shot sequence with surface coil correction. The sequence parameters were: TE/TR=1/4.1 msec; effective TE=60 msec; flip angle=90° and voxel size=2.1×1.6×8.0 mm Native ShMOLLI T1 maps were generated from 5-7 SSFP images with variable inversion preparation time. Typical sequence parameters were: TE/TR=1.07/2.14 msec, flip angle=35°, FOV=340×255 mm, matrix size=192×144, 107 phase encoding steps, actual experimental voxel size=1.8×1.8×8.0 mm, interpolated reconstructed voxel size=0.9×0.9×8.0 mm, GRAPPA=2, 24 reference lines, cardiac delay time TD=500 msec and 206 msec acquisition time for single image, phase partial Fourier 6/8. LGE was performed with a T1-weighted segmented inversion recovery gradient-echo phase-sensitive inversion recovery (GRE_PSIR) sequence (TE/TR=2.5 msec/5 msec, voxel size 1.8×1.4×8 mm, flip angle 20°). Images were acquired 10-15 min after contrast agent administration (0.1 mmol/kg of gadoteratemeglumine, Dotarem, Guerbet, Villepinte, France). The inversion time was adjusted for optimal nulling of remote normal myocardium. SSFP cine images were acquired using retrospective gating with the following sequence parameters: TE/TR=1.4/3.2 msec; flip angle=50° and voxel size: 1.6×1.6×8 mm.

Matching short-axis slices covering the left ventricle were analysed using cvi42 software (Circle Cardiovascular Imaging Inc., Canada) by two expert and independent operators, both blind to clinical, procedural and coronary physiology data. Disagreement was resolved by consensus. Left ventricular end diastolic volume, end systolic volume, and ejection fraction were assessed on cine images. Area at risk and infarct size (IS) were quantified as percentage of left ventricle mass on T2W (on native T1 if T2W not available) and LGE, respectively, by placing a reference region of interest in remote myocardium and setting the signal intensity threshold at 2 and 5 standard deviations above the mean intensity of the reference region of interest, respectively (References 20 to 22).

Myocardial salvage index was calculated as previously described (Reference 21) as [(Area at risk−Infarct Size)/Area at risk]*100. Microvascular obstruction was defined as hypointense area within the hyperenhancement region on the late gadolinium enhancement images, and was manually contoured (Reference 20). Presence of haemorrhage was assessed firstly visually on T2* maps and/or T2W imaging by identifying a hypointense core inside the hyperenhanced region (References 23 and 24), and was then quantified from the T2W images by setting the signal intensity threshold at two standard deviations below the average intensity of the reference region of interest in the periphery of the area at risk (Reference 24).

A subset of the spectra were analysed using a number of unsupervised and supervised multivariate analysis methods within the PyChem software suite (Reference 25). Spectra of 20 samples from patients with large MVO, and 18 spectra from patients without MVO were selected, with the aim being to determine the extent to which the thrombus spectra could be used to classify the patients into these two groups. For this kind of analysis, the spectra were preliminarily cropped to the wavelength range from 500 to 800 nm, smoothed using a 10-point average, and normalised to unit area under the curve.

FIG. 9 shows averages of normalised spectra belonging to the two patient groups and clear differences are apparent on visual inspection. The average spectrum for the low-risk (MVO=0) patients is relatively featureless over the wavelength range of interest, whereas that for the high-MVO patients is much more structured.

First, principal component analysis (PCA) was performed. FIG. 10 shows a plot of the first two principal components obtained when the data set is subjected to PCA. Spectra recorded for thrombus samples from patients with MVO=0 are clustered together, whereas spectra for patients with high MVO values are spread across the plot. Even this simple unsupervised analysis therefore provides reasonable separation of the two patient categories.

Following PCA, the principal components were used to perform discriminant function analysis (DFA) based on the two patient groups described above. PCA is an unsupervised method, in which the algorithm does not ‘know’ to which patient group each spectrum corresponds, while DFA is a supervised method, in which the information on patient group forms part of the algorithm during the training phase. DFA is therefore able to identify the spectral features of most interest for differentiating between patient groups, information that is generally presented in the form of ‘loadings’ for each wavelength.

FIGS. 11 and 12 show the results of the discriminant function analysis on the same data set. The DFA provides reasonable separation between the two categories of patients. If we define a threshold value of −0.5, we find that 33 out of 38 patients are correctly categorised. The loading plot in FIG. 12 identifies which wavelength regions are most important in distinguishing the two classes of patients. The region either side of the ‘crossover point’ near 590 nm between the averaged spectra shown in FIG. 9 is clearly key in distinguishing between samples from patients with high and low MVO. Accordingly, the plural number of wavelengths applied in the methods described herein will preferably include a wavelength in a range from 585 nm to 595 nm

Following the preliminary analysis, the loading coefficients for each wavelength in the discriminant function were then used to narrow down the wavelength range of most interest to the region from 500 to 650 nm. The spectra were then cropped to this wavelength range, renormalized, and the analysis repeated. The drawings show this second round of analysis, for which the wavelength range has been optimised.

To test the robustness of the multivariate analysis, the discriminant function analysis was repeated, but this time, instead of using the complete data set as a training set, the data were split into training and test sets. The results of this analysis are shown in FIG. 13. We see that even with a much smaller training set, when employing a threshold of 0, the model is able to correctly classify 17 out of 19 patients in the test data set.

In addition to PCA and DFA, the spectra were also subjected to a cluster analysis, which is an unsupervised algorithm in which one of a number of different ‘distance’ measures is used to quantify the differences between spectra. Classification succeeded with various distance measures, Euclidean distance being found to provide the best separation between the two patient groups. FIG. 14 shows the results of the cluster analysis when employing the Euclidean distance measure.

This work validates the methods as a diagnostic tool in AMI patients, and it is similarly expected that the methods may be applied to other conditions which produce thrombus. Some examples of such conditions are set about above and include stroke.

Stroke is commonly the result of acute thrombosis/embolus to the cerebral arteries, leading to acute cessation of blood flow to the brain. This leads to infarction of the brain tissue and subsequent tissue damage and loss of neurological function. The latest NICE guideline (IPG548) recommends mechanical clot retrieval for treating acute ischaemic stroke in adults. This involves using a device to remove the blood clot from the brain to restore normal blood flow. The clinical efficacy of this treatment is summarised by the evidence listed in this guideline. Retrieval of the thrombus from the cerebral artery in such emergencies can restore the circulation to the brain, and prompt resolution of symptoms. As such, there are significant parallels between the clinical entities of myocardial infarction and brain infarction (stroke).

To investigate the efficacy of minimising the number of wavelengths used, the measured spectra described above were used to simulate spectra for a small number of wavelengths, in particular by integrating the relevant regions of each spectrum over the wavelength range that would be transmitted by a 10 nm bandwidth bandpass filter centred at six selected wavelengths (in this example being 500 nm, 540 nm, 560 nm, 580 nm, 600 nm and 640 nm). Such sets of six-wavelength spectra were then subjected to the same analysis as the full spectra, and yielded similar results in terms of the ability to classify the samples. This is consistent with the full spectra only having fairly broad features. As such, it is believed that a much reduced number of wavelengths could still provide useful classification. The minimum number of wavelengths required is equal to the number of categories into which the samples are to be classified, with additional wavelengths serving to confirm and potentially improve the classification.

This demonstrates that good discriminatory power is achieved when the plural number is at least four, preferably at least six. This allows the number of wavelengths used to be reduced which simplifies the taking of measurements. The number of wavelengths may be, for example at most 50, at most 20 or at most 10.

The second approach using a spectral imaging system to record reflectance images was carried out as follows.

Spectral reflectance images were recorded captured using the alternative form of the optical measurement device 2 shown in FIG. 15 for the frozen thrombus samples on supports 21 which were the filters in which they were originally collected during the catheterisation and extraction procedure.

FIG. 16 shows an example of a set of reflectance images from a single thrombus sample. Clear differences are apparent between the intensities of light reflected from the sample at each of the wavelengths employed, with particular regions of the image appearing darker or brighter at different wavelengths.

FIG. 17 shows the results of a clustering analysis performed on the image from FIG. 16, in which the pixels of the image are separated into four groups based on similarities and differences in their reflectance spectra, the four groups being shaded with different greyscale levels.

Although this validation work relates specifically to reflectance measurements, it is expected that similar efficacy will be available from Raman spectroscopy. In Raman spectroscopy, the wavelengths of scattered electromagnetic radiation provide information on rotational, vibrational and/or electronic transitions within the sample, similarly to the reflectance measurements. The Raman spectrum of the different components will be different, and therefore sufficient to differentiate between different types of thrombus in essentially the same way as the reflectance spectra.

That said, Raman scattering has the disadvantages that categorisation of spectra from different tissue or cell types often relies on relatively small differences between large signals, and equipment costs are generally much higher than for UV/visible or IR reflectance spectroscopy. Reflectance spectra are more straightforward to measure, and the required equipment is much less expensive to set up. This is particularly true in imaging applications, with Raman microscopes costing 10 to 100 times more than a simple spectral imaging camera. Raman scattering is, however, widely used in clinical applications as an alternative to IR spectroscopy as a consequence of the fact that absorption by water in the sample is avoided at the laser wavelengths employed.

As mentioned above, according to a third aspect of the present invention, there is provided an apparatus for characterising a sample comprising thrombus collected from a patient, the apparatus comprising an optical measurement device arranged to receive the sample and comprising an illumination system arranged to illuminate the sample with optical electromagnetic radiation and a detector arranged to detect electromagnetic radiation scattered by the sample at a plural number of wavelengths.

In accordance with this aspect, the following features may optionally be applied in any combination.

The optical electromagnetic radiation may have a wavelength in a range from a lower limit of 100 nm to an upper limit of 1 mm. Alternatively, the lower limit may be 190 nm and/or the upper limit may be 20 μm.

The wavelengths may include a wavelength in a range from 585 nm to 595 nm.

The detector may be arranged to detect electromagnetic radiation reflected at a plural number of wavelengths to derive the reflectance of the sample at the plural number of wavelengths.

The optical measurement device may further comprise plural wavelength-selective filters corresponding to the plural number of wavelengths, in which case the detector may be arranged to detect the electromagnetic radiation reflected at the plural number of wavelengths from light reflected from the sample and having a wavelength selected by passage through respective filters.

The optical measurement device nay comprise a movable element in which the plural wavelength-selective filters are mounted, and a drive arrangement arranged to move the movable element so as to pass light reflected from the sample through each of the filters in turn.

The plural number may be at least three, preferably at least four, at least five or more preferably at least six.

Alternatively, the plural number of wavelengths may be a continuous spectrum of wavelengths, in which case the detector may comprise a spectrometer.

The optical measurement device may be arranged to receive the sample disposed on a filter.

The detector may be arranged to detect electromagnetic radiation averaged across an area of the sample.

The apparatus may further comprise a computer system arranged to classify the composition of the sample on the basis of the detected electromagnetic radiation.

The optical measurement device may be arranged to receive the sample disposed on a support, in which case the computer system may be arranged to analyse the detected electromagnetic radiation to determine the contribution thereto of the support, to adjust the detected electromagnetic radiation to remove the contribution thereto of the support, and to classify the sample on the basis of the detected electromagnetic radiation after being adjusted.

The computer system may be arranged to classify the composition sample by comparison to reference data representing possible classifications of compositions.

### REFERENCES

Reference 1: Libby P. Mechanisms of acute coronary syndromes and their implications for therapy. N Engl J Med. 2013; 368:2004-13
Reference 2: Ibanez B, James S, Agewall S, Antunes M J, Bucciarelli-Ducci C, Bueno H, et al. 2017 ESC Guidelines for the management of acute myocardial infarction in patients presenting with ST-segment elevation: The Task Force for the management of acute myocardial infarction in patients presenting with ST-segment elevation of the European Society of Cardiology (ESC); doi: 10.1093/eurheartj/ehx393. Eur Heart J. 2017
Reference 3: De Maria G L, Cuculi F, Patel N, Dawkins S, Fahrni G, Kassimis G, et al. How does coronary stent implantation impact on the status of the microcirculation during primary percutaneous coronary intervention in patients with ST-elevation myocardial infarction? Eur Heart J. 2015
Reference 4: Niccoli G, Burzotta F, Galiuto L, Crea F. Myocardial no-reflow in humans. J Am Coll Cardiol. 2009; 54:281-92.
Reference 5: Ndrepepa G, Tiroch K, Fusaro M, Keta D, Seyfarth M, Byrne R A, et al. 5-year prognostic value of no-reflow phenomenon after percutaneous coronary intervention in patients with acute myocardial infarction. J Am Coll Cardiol. 2010; 55:2383-9.
Reference 6: Harrison R W, Aggarwal A, Ou F S, Klein L W, Rumsfeld J S, Roe M T, et al. Incidence and outcomes of no-reflow phenomenon during percutaneous coronary intervention among patients with acute myocardial infarction. Am J Cardiol. 2013; 111:178-84.
Reference 7: Morishima I, Sone T, Okumura K, Tsuboi H, Kondo J, Mukawa H, et al. Angiographic no-reflow phenomenon as a predictor of adverse long-term outcome in patients treated with percutaneous transluminal coronary angioplasty for first acute myocardial infarction. J Am Coll Cardiol. 2000; 36:1202-9.
Reference 8: Task Force on the management of ST-segment elevation acute myocardial infarction of the European Society of Cardiology. ESC Guidelines for the management of acute myocardial infarction in patients presenting with ST-segment elevation. Eur Heart J. 2012; 33:2569-619.
Reference 9: Vlaar P J, Svilaas T, van der Horst I C, Diercks G F, Fokkema M L, de Smet B J, et al. Cardiac death and reinfarction after 1 year in the Thrombus Aspiration during Percutaneous coronary intervention in Acute myocardial infarction Study (TAPAS): a 1-year follow-up study. Lancet. 2008:1915-20.
Reference 10: Frobert O, Lagerqvist B, Olivecrona G K, Omerovic E, Gudnason T, Maeng M, et al. Thrombus aspiration during ST-segment elevation myocardial infarction. N Engl J Med. 2013; 369:1587-97.
Reference 11: Jolly S S, Cairns J A, Yusuf S, Meeks B, Pogue J, Rokoss M J, et al. Randomized trial of primary PCI with or without routine manual thrombectomy. N Engl J Med. 2015; 372:1389-98.
Reference 12: Jolly S S, James S, Džavík V, Cairns J A, Mahmoud K D, Zijlstra F, et al. Thrombus Aspiration in ST-Segment-Elevation Myocardial Infarction: An Individual Patient Meta-Analysis: Thrombectomy Trialists Collaboration. Circulation. 2017; 135:143-52.
Reference 13: Mahmoud K D, Zijlstra F. Thrombus aspiration in acute myocardial infarction. Nat Rev Cardiol. 2016:418-28.
Reference 14: Kramer M C, van der Wal A C, Koch K T, Rittersma S Z, Li X, Ploegmakers H P, et al. Histopathological features of aspirated thrombi after primary percutaneous coronary intervention in patients with ST-elevation myocardial infarction. PLoS One. 2009; 4:e5817.
Reference 15: Yunoki K, Naruko T, Sugioka K, Inaba M, Iwasa Y, Komatsu R, et al. Erythrocyte-rich thrombus aspirated from patients with ST-elevation myocardial infarction: association with oxidative stress and its impact on myocardial reperfusion. Eur Heart J. 2012; 33:1480-90.
Reference 16: Yunoki K, Naruko T, Inoue T, Sugioka K, Inaba M, Iwasa Y, et al. Relationship of thrombus characteristics to the incidence of angiographically visible distal embolization in patients with ST-segment elevation myocardial infarction treated with thrombus aspiration. JACC Cardiovasc Interv. 2013; 6:377-85.
Reference 17: Quadros A S, Cambruzzi E, Sebben J, David R B, Abelin A, Welter D, et al. Red versus white thrombi in patients with ST-elevation myocardial infarction undergoing primary percutaneous coronary intervention: clinical and angiographic outcomes. Am Heart J. 2012; 164:553-60.
Reference 18: Cuculi F, Dall'Armellina E, Manlhiot C, De Caterina A R, Colyer S, Ferreira V, et al. Early change in invasive measures of microvascular function can predict myocardial recovery following PCI for ST-elevation myocardial infarction. Eur Heart J. 2014; 35:1971-80.
Reference 19: Liu D, Borlotti A, Viliani D, Jerosch-Herold M, Alkhalil M, De Maria G L, et al. CMR Native T1 Mapping Allows Differentiation of Reversible Versus Irreversible Myocardial Damage in ST-Segment-Elevation Myocardial Infarction: An OxAMI Study (Oxford Acute Myocardial Infarction). Circ Cardiovasc Imaging. 2017; 10.
Reference 20: Masci P G, Ganame J, Strata E, Desmet W, Aquaro G D, Dymarkowski S, et al. Myocardial salvage by CMR correlates with LV remodeling and early ST-segment resolution in acute myocardial infarction. JACC Cardiovasc Imaging. 2010; 3:45-51.
Reference 21: Eitel I, Desch S, Fuernau G, Hildebrand L, Gutberlet M, Schuler G, et al. Prognostic significance and determinants of myocardial salvage assessed by cardiovascular magnetic resonance in acute reperfused myocardial infarction. J Am Coll Cardiol. 2010; 55:2470-9.
Reference 22: Ugander M, Bagi P S, Oki A J, Chen B, Hsu L Y, Aletras A H, et al. Myocardial edema as detected by pre-contrast T1 and T2 CMR delineates area at risk associated with acute myocardial infarction. JACC Cardiovasc Imaging. 2012; 5:596-603.
Reference 23: Carrick D, Haig C, Ahmed N, Carberry J, Yue May V T, McEntegart M, et al. Comparative Prognostic Utility of Indexes of Microvascular Function Alone or in Combination in Patients With an Acute S T-Segment-Elevation Myocardial Infarction. Circulation. 2016; 134:1833-47.
Reference 24: Payne A R, Berry C, Doolin O, McEntegart M, Petrie M C, Lindsay M M, et al. Microvascular Resistance Predicts Myocardial Salvage and Infarct Characteristics in ST-Elevation Myocardial Infarction. J Am Heart Assoc. 2012; 1:e002246.
Reference 25: Jarvis R M, Broadhurst D, Johnson H E, O'Boyle N, Goodacre R. PyChem—a multivariate analysis package for Python. Bioinformatics. 2006; 22:2565-6.

1. A method of characterising a sample comprising thrombus collected from a patient, the method comprising:
illuminating the sample with optical electromagnetic radiation;
detecting electromagnetic radiation scattered by the sample at a plural number of wavelengths; and
classifying the composition of the sample using a spectral analysis of the detected electromagnetic radiation at the plural number of wavelengths.

2. A method according to claim 1, wherein the optical electromagnetic radiation has a wavelength in a range from a lower limit of 100 nm to an upper limit of 1 mm.

3. A method according to claim 2, wherein the lower limit is 190 nm.

4. A method according to claim 2, wherein the upper limit is 20 μm.

5. A method according to claim 1, wherein the wavelengths include a wavelength in a range from 585 nm to 595 nm.

6. A method according to claim 1, wherein the step of detecting electromagnetic radiation comprises detecting electromagnetic radiation reflected at the plural number of wavelengths to derive the reflectances of the sample at the plural number of wavelengths; and the step of classifying the composition of the sample uses a spectral analysis of the derived reflectances at the plural number of wavelenghts.

7. A method according to claim 6, wherein the step of detecting electromagnetic radiation reflected at a plural number of wavelengths is performed by detecting electromagnetic radiation reflected from the sample and having wavelengths selected by passage through plural wavelength-selective filters corresponding to the plural number of wavelengths.

8. A method according to claim 6, wherein the plural number is at least three, preferably at least four, at least five or more preferably at least six.

9. A method according to claim 6, wherein the plural number of wavelengths are a continuous spectrum of wavelengths.

10. A method according to claim 9, wherein the step of detecting electromagnetic radiation is performed using a spectrometer to measure light reflected from the sample.

11. A method according to 6, wherein the step of classifying the composition of the sample using the reflectances comprises
transforming the reflectances into a vector having a number of dimensions less than the number of wavelengths, and
classifying the sample on the basis of the vector.

12. A method according to claim 1, wherein the step of detecting electromagnetic radiation scattered by the sample comprises detecting electromagnetic radiation that is Raman scattered over a range of frequencies; and the step of classifying the composition of the sample using the Raman scattered electromagnetic radiation.

13. A method according to claim 1, wherein the detected electromagnetic radiation is averaged across an area of the sample.

14. A method according to claim 1, wherein step of detecting electromagnetic radiation scattered by the sample at a plural number of wavelengths comprises detecting images of electromagnetic radiation scattered by different points of the sample at the plural number of wavelengths.

15. A method according to claim 14, wherein the step of classifying the composition of the sample comprises classifying the composition of the sample at each of the pixels of the image.

16. A method according to claim 14, wherein the step of classifying the composition of the sample comprises clustering the pixels of the images into groups using a spectral analysis of detected electromagnetic radiation at the plural number of wavelengths to identify groups that are similar.

17. A method according to claim 16, wherein the step of classifying the composition of the sample comprises further comprises classifying the groups of pixels using a spectral analysis of detected electromagnetic radiation at the plural number of wavelengths by comparison to reference data representing possible classifications of compositions.

18. A method according to claim 1, wherein
the step of detecting electromagnetic radiation is performed with the sample disposed on a support,
the method further comprises analysing the detected electromagnetic radiation to determine the contribution thereto of the support, and adjusting the detected electromagnetic radiation to remove the contribution thereto of the support, and
the step of classifying the sample is performed on the basis of the detected electromagnetic radiation after being adjusted.

19. A method according to claim 1, wherein the step of classifying the composition of the sample is performed by comparison to reference data representing possible classifications of compositions.

20. A method according to claim 1, wherein the sample is collected from a patient and the method further comprises selecting a treatment for the patient based on the classification.

21. A method according to claim 1, wherein the step of detecting electromagnetic radiation scattered by the sample is performed with the sample disposed on a filter.

22. A method according to claim 1, further comprising collecting the sample.

23. A method according to claim 1, wherein the step of classifying the composition of the sample comprises classifying the sample with respect to a degree of a clinical marker.

24. A method according to claim 23, wherein the clinical marker is microvascular obstruction.

25. A method according to claim 1, wherein the sample comprises thrombus collected from a coronary artery of a patient suffering an acute myocardial infarction.

26. A method of characterising a sample comprising thrombus collected from a patient, the method comprising classifying the composition of the sample using a spectral analysis of detected electromagnetic radiation scattered at a plural number of wavelengths by the sample that is illuminated with optical electromagnetic radiation.

27. A computer program capable of execution by a computer system and configured, on execution, to cause the computer system to perform a method according to claim 26.

28. A computer-readable storage medium storing a computer program according to claim 27.

28. A computer system arranged to perform a method according to claim 26.

30. An apparatus for characterising a sample comprising thrombus collected from a patient, the apparatus comprising an optical measurement device arranged to receive the sample and comprising an illumination system arranged to illuminate the sample with optical electromagnetic radiation and a detector arranged to detect electromagnetic radiation scattered by the sample at a plural number of wavelengths.
